(19) United States
(12) Patent Application Publication
(10) Pub. No.: US 2004/0257342 A1
(43) Pub. Date: Dec. 23, 2004

(54) Keyboard switchable between a computer mode and a calculator mode

(76) Inventors: Yen-Chang Chiu, Taipei (TW); Chin-Nan Wu, Tainan City (TW); Ben-Jang Sun, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/828,223

(22) Filed: Apr. 21, 2004

(30) Foreign Application Priority Data
Apr. 22, 2003 (TW) 092206400

(51) Int. Cl. G09G 5/00

(52) U.S. Cl. 345/168

(57) ABSTRACT

In a keyboard switchable between a computer mode and a calculator mode, a plurality of keys, a processor, a calculator controller, a calculator display and a transmission apparatus are comprised. The processor scans the plurality of keys and transmits calculator key signals to the calculator controller to perform calculation under the calculation mode, and the calculation result is displayed on the calculator display. The transmission apparatus transmits the calculator key symbols and calculation result to an external apparatus by wired or wireless transmission under the calculator mode.

### FIELD OF THE INVENTION

The present invention relates generally to a keyboard and, more specifically, to a keyboard switchable between a computer mode and a calculator mode.

### BACKGROUND OF THE INVENTION

Numeral calculations by operating a calculator are often required for commercial and engineering matters, and the calculation result is further required to be inputted to a computer for further use or storage. This procedure costs long-term of time and does not display the detail of the calculation operation, thereby resulting in difficulties to debug. To improve it, in Taiwan Patent Application No. 77,211,410 issued to Sun et al., a keyboard equipped with a calculator function is proposed. However, this art is implemented by inserting a calculator on a conventional keyboard additionally, i.e., it is obtained by assembling two conventional apparatus together, in which two controllers operate individual function, respectively, as two individual conventional apparatus did, such that it is still disadvantageous for use and is cost much. Moreover, the data transmitted by this modified keyboard are limited by wired transmission interface, resulting in inconvenience of use and low functioning.

On the other hand, the computer user sometimes needs a calculator for numeral calculations for example during preparing a report. In this circumstance, the calculation equation may need to be shown in the report, and thus, typing of the calculation equation and numbers thereof is repeated on the calculator for calculation and the computer for editing, respectively. More serious, double typing may introduce typing errors, and double check is thus required.

Accordingly, it is desired a keyboard switchable between a computer mode and a calculator mode.

### SUMMARY OF THE INVENTION

One object of the present invention is to provide a keyboard switchable between a computer mode and a calculator mode.

Another object of the present invention is to provide a keyboard having wired or wireless interface for the user to transmit the calculation detail and the calculation result to an external apparatus.

In one embodiment, a keyboard comprises a plurality of keys, a processor, a transmission apparatus, a calculator controller and a calculator display. The processor scans the plurality of keys and, under calculator mode, transmits the calculator key signals to the calculator controller to perform the calculation and display the calculation result on the calculator display. Under the calculator mode, the transmission apparatus can transmit the calculator key symbols and the calculation result to an external apparatus by wired or wireless transmission.

In another embodiment, a keyboard comprises a plurality of keys, a processor, a transmission apparatus and a calculator display. The processor scans the plurality of keys and, under calculator mode, performs the calculation and displays the calculation result on the calculator display. Under the calculator mode, the transmission apparatus can transmit the calculator key symbols and the calculation result to an external apparatus by wired or wireless transmission.

In yet another embodiment, a keyboard comprises a plurality of keys, a processor, a transmission apparatus, a calculator controller and a calculator display. The calculator controller scans the plurality of keys and, under computer mode, transmits the computer key signals to the processor. Under calculator mode, the calculator controller performs the calculation and displays the calculation result on the calculator display, and the transmission apparatus can transmit the calculator key symbols and the calculation result to an external apparatus by wired or wireless transmission.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows first embodiment of the present invention;

FIG. 2 shows second embodiment of the present invention; and

FIG. 3 shows third embodiment of the present invention.

### DETAILED DESCRIPTION OF THE INVENTION

[First Embodiment]

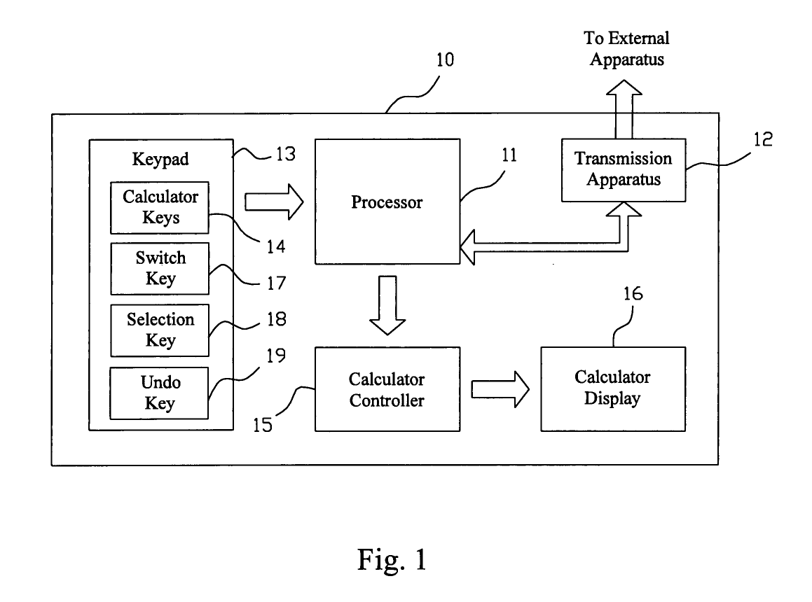

FIG. 1 is a block diagram to show a keyboard 10 that comprises a processor 11, a transmission apparatus 12, a keypad 13 having a plurality of keys thereon, a calculator controller 15, and a calculator display 16. Among the keys on the keypad 13, a group of calculator keys 14, i.e., engineering and commercial calculation keys, are included for operations of engineering and commercial calculation, which include conventional numeral keys and predefined hot keys and hardware keys.

Preferably, there is included a switch key 17 among the plurality of keys on the keypad 13 to switch the keyboard 10 between a computer mode and a calculator mode. In addition, a selection key 18 is provided thereof to select transmission of the key symbols and calculation result by the transmission apparatus 12 or not under the calculator mode. Either the switch key 17 or the selection key 18 can be implemented by the hot key or hardware key.

Under the calculator mode, there may be a need for the calculation equation and numbers thereof to be re-typed after they are transmitted to the transmission apparatus 12 due to error operations such as typing error, and thus an undo key 19 could be further provided on the keypad 13 for the user to delete the last data transmitted to the transmission apparatus 12. If the data to be deleted is still stored in the keyboard 10, instead of transmitted to the external apparatus, the delete operation is performed only to the memory in the keyboard 10. This delete function is so designed that a pressing of the undo key 19 delete an entry of data.

Special function key can be provided on the keyboard 10 by defining a keys combination that represents an operator or a calculator key under the calculator mode. In a typical calculator, an operator for example a square root is typed after its operand, while they are displayed on the monitor in an opposite sequence for the user easy to read. To meet this requirement, when an equation is transmitted to the transmission apparatus 12, each operator will be transmitted to the transmission apparatus 12 together with its operand in an easy-to-read sequence, such that they can be read in the conventional manner one to read an equation on a monitor.

The transmission apparatus 12 may include wired interface such as USB and PS/2, or wireless interface such as IrDA and RF (Radio frequency) interfaces.

The processor 11 scans the keypad 13 as a conventional keyboard does. Under the calculator mode, however, the processor 11 transmits calculator key signals to the calculator controller 15 according to the keys it scanned, and the calculator controller 15 receives those calculator key signals to practice the calculation and display the calculation result on the calculator display 16.

[Second Embodiment]

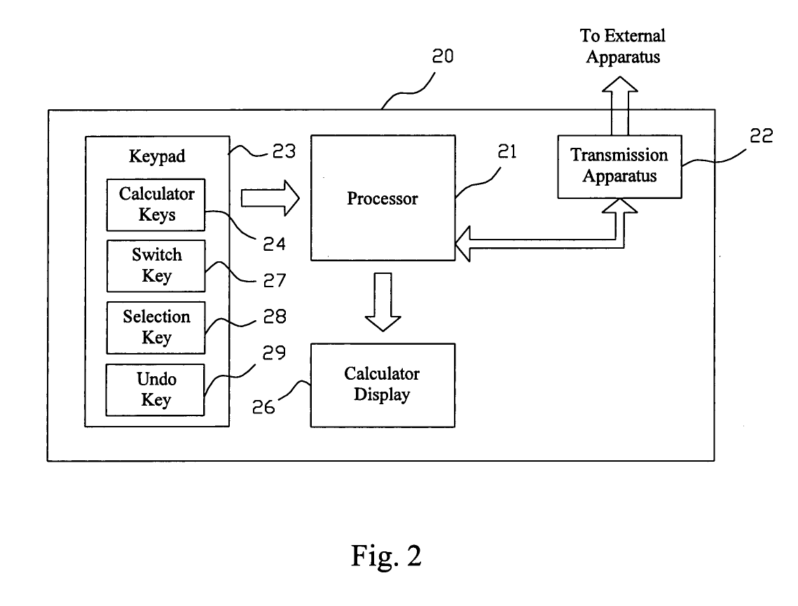

FIG. 2 shows another keyboard 20 that comprises a processor 21, a transmission apparatus 22, a keypad 23 having a plurality of keys thereon, and a calculator display 26. Among the keys on the keypad 23, a group of calculator keys 24, i.e., engineering and commercial calculation keys, are included for operations of engineering and commercial calculation, which include conventional numeral keys and predefined hot keys and hardware keys.

There are also included a switch key 27 among the plurality of keys on the keypad 23 to switch the keyboard 20 between a computer mode and a calculator mode, and a selection key 28 to select transmission of the key symbols and calculation result by the transmission apparatus 22 or not under the calculator mode. Either the switch key 27 or the selection key 28 can be implemented by the hot key or hardware key.

It is also included an undo key 29 on the keypad 23. Once the undo key 29 is pressed, the last entry of data transmitted to the transmission apparatus 22 is deleted, and one entry of data is deleted per one pressing of the undo key 29.

Similarly, keys combination can be defined as an operator or a calculator key for the calculator mode operation. When an equation is transmitted to the transmission apparatus 22, it is re-arranged in the sequence with each operator followed by its operand, for the user easy to read the equation on the monitor of the external apparatus. The transmission apparatus 22 may include wired interface such as USB and PS/2, or wireless interface such as IrDA and RF (Radio frequency) protocols.

In this embodiment, the processor 11 scans the keypad 23 as a conventional keyboard does, while under the calculator mode, the processor 21 will perform the calculation and display the calculation result on the calculator display 26 as a conventional calculator does.

[Third Embodiment]

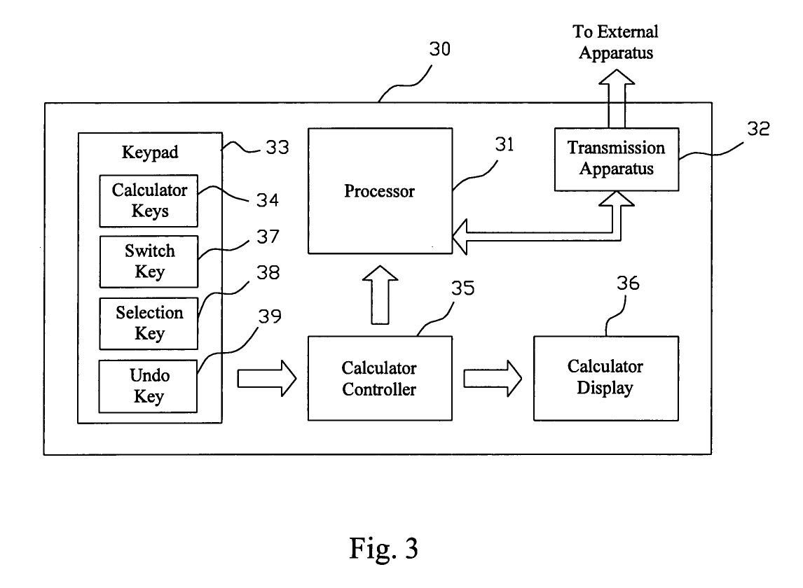

A keyboard 30 shown in FIG. 3 comprises a processor 31, a transmission apparatus 32, a keypad 33 having a plurality of keys thereon, a calculator controller 35, and a calculator display 36. Among the keys on the keypad 33, a group of calculator keys 34, i.e., engineering and commercial calculation keys, are included for operations of engineering and commercial calculation, which include conventional numeral keys and predefined hot keys and hardware keys. Again, switch key 37, selection key 39 and undo key 39 are provided on the keypad 33 by hot keys and hardware keys. The transmission apparatus 32 may include wired interface such as USB and PS/2, or wireless interface such as IrDA and RF (Radio frequency) protocols.

The functions and operations of the keyboard 30 are similar to those of the keyboard 10. However, the keypad 33 is scanned by the calculator controller 35 instead, and under the computer mode, the calculator controller 35 will transmit the computer key signals based on its scan to the processor 31 for computer keyboard operations. Under the calculator mode, the calculator controller 35 scans the keypad 33 and performs the calculation, and the calculation is transmitted to the calculator display 36.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A keyboard switchable between a computer mode and a calculator mode, comprising:
a plurality of keys including a group of engineering and commercial calculation keys for operation under said calculator mode;
a processor for scanning said plurality of keys;
a calculator controller for receiving a plurality of calculator key signals from said processor for calculation under said calculator mode;
a calculator display for displaying a calculation result; and
a transmission apparatus for wired or wireless transmission of one or more key symbols and said calculation result to an external apparatus under said calculator mode.

2. The keyboard of claim 1, wherein said plurality of keys include a switch key for switching said keyboard between said computer mode and calculator mode.

3. The keyboard of claim 1, wherein said plurality of keys include a selection key for selecting said wired or wireless transmission by said transmission apparatus or not under said calculator mode.

4. The keyboard of claim 1, wherein said plurality of keys include an undo key for deleting a last key symbol or a last calculation result transmitted to said transmission apparatus under said calculator mode.

5. The keyboard of claim 1, wherein said plurality of keys include a keys combination for representing an operator or a calculator key under said calculator mode.

6. The keyboard of claim 1, wherein said transmission apparatus includes a USB interface.

7. The keyboard of claim 1, wherein said transmission apparatus includes a PS/2 interface.

8. The keyboard of claim 1, wherein said transmission apparatus includes an IrDA interface.

9. The keyboard of claim 1, wherein said transmission apparatus includes a RF interface.

10. A keyboard switchable between a computer mode and a calculator mode, comprising:
a plurality of keys including a group of engineering and commercial calculation keys for operation under said calculator mode;
a processor for scanning said plurality of keys and performing a calculation under said calculator mode;
a calculator display for displaying a calculation result; and
a transmission apparatus for wired or wireless transmission of one or more key symbols and said calculation result to an external apparatus under said calculator mode.

11. The keyboard of claim 10, wherein said plurality of keys include a switch key for switching said keyboard between said computer mode and calculator mode.

12. The keyboard of claim 10, wherein said plurality of keys include a selection key for selecting said wired or wireless transmission by said transmission apparatus or not under said calculator mode.

13. The keyboard of claim 10, wherein said plurality of keys include an undo key for deleting a last key symbol or a last calculation result transmitted to said transmission apparatus under said calculator mode.

14. The keyboard of claim 10, wherein said plurality of keys include a keys combination for representing an operator or a calculator key under said calculator mode.

15. The keyboard of claim 10, wherein said transmission apparatus includes a USB interface.

16. The keyboard of claim 10, wherein said transmission apparatus includes a PS/2 interface.

17. The keyboard of claim 10, wherein said transmission apparatus includes an IrDA interface.

18. The keyboard of claim 10, wherein said transmission apparatus includes an RF interface.

19. A keyboard switchable between a computer mode and a calculator mode, comprising:
a plurality of keys including a group of engineering and commercial calculation keys for operation under said calculator mode;
a calculator controller for scanning said plurality of keys and performing a calculation under said calculator mode;
a processor for receiving a plurality of computer key signals from said calculator controller under said computer mode;
a transmission apparatus for wired or wireless transmission of one or more key symbols and said calculation result to an external apparatus under said calculator mode.

20. The keyboard of claim 19, wherein said plurality of keys include a switch key for switching said keyboard between said computer mode and calculator mode.

21. The keyboard of claim 19, wherein said plurality of keys include a selection key for selecting said wired or wireless transmission by said transmission apparatus or not under said calculator mode.

22. The keyboard of claim 19, wherein said plurality of keys include an undo key for deleting a last key symbol or a last calculation result transmitted to said transmission apparatus under said calculator mode.

23. The keyboard of claim 19, wherein said plurality of keys include a keys combination for representing an operator or a calculator key under said calculator mode.

24. The keyboard of claim 19, wherein said transmission apparatus includes a USB interface.

25. The keyboard of claim 19, wherein said transmission apparatus includes a PS/2 interface.

26. The keyboard of claim 19, wherein said transmission apparatus includes an IrDA interface.

27. The keyboard of claim 19, wherein said transmission apparatus includes an RF interface.
